(19) United States
(12) Patent Application Publication
(10) Pub. No.: US 2026/0237138 A1
(43) Pub. Date: Aug. 13, 2026

(54) MANAGEMENT AND AUTHORIZATION OF BASE AVATARS FOR USE DURING AR COMMUNICATION SESSIONS

(71) Applicant: QUALCOMM Incorporated, San Diego, CA (US)

(72) Inventors: Imed Bouazizi, Celina, TX (US); Thomas Stockhammer, Bergen (DE); Liangping Ma, San Diego, CA (US)

(21) Appl. No.: 19/534,409

(22) Filed: Feb. 9, 2026

Related U.S. Application Data
(60) Provisional application No. 63/756,913, filed on Feb. 11, 2025.

(51) Int. Cl. G06T 13/40; H04L 9/40

(52) U.S. Cl. CPC G06T 13/40; H04L 63/102

(57) ABSTRACT

An example device for communicating augmented reality (AR) media data includes: a memory configured to store media data; and a processing system implemented in circuitry and configured to: obtain data representing a base avatar and one or more avatar assets associated with an AR user, wherein the data indicates that a base avatar repository device stores the base avatar and the one or more avatar assets; initiate an AR communication session including the AR user; and send an access token to a client device associated with at least one other user involved in the AR communication session, the access token indicating that the at least one other user has access to the base avatar and a selection of the one or more avatar assets.

This application claims the benefit of U.S. Provisional Application No. 63/756,913, filed Feb. 11, 2025, the entire contents of which are hereby incorporated by reference.

### TECHNICAL FIELD

This disclosure relates to transport of media data, in particular, augmented reality (AR) media data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), ITU-T H.265 (also referred to as High Efficiency Video Coding (HEVC)), and extensions of such standards, to transmit and receive digital video information more efficiently.

After media data has been encoded, the media data may be packetized for transmission or storage. The video data may be assembled into a media file conforming to any of a variety of standards, such as the International Organization for Standardization (ISO) base media file format and extensions thereof.

### SUMMARY

In general, this disclosure describes techniques for processing augmented reality (AR) media data, such as extended reality (XR) media data. XR media data may include any or all of AR data, mixed reality (MR) data, or virtual reality (VR) data. This disclosure generally describes the use of AR data, although any of the various types of XR data may be used in addition or in the alternative. During an AR communication session, a user may be represented by an avatar. The avatar may correspond to a base model. Throughout the AR communication session, the user may move their body, face, hands, or the like. These movements may be tracked by various devices, and this tracked data may be used to animate the base model of the avatar.

For example, the avatar may be animated to match movements of the user, facial expressions of the user, poses of the user, or the like. The base model and tracked movement data may be tracked in different frameworks, which may have different representations and capacities for expressing movements, such as different facial expressions, different rigging skeletons (sets of bones and joints) for the base model, or the like. This disclosure describes techniques that may be used to manage such base models and to authorize AR communication session participants to retrieve such base models from a base avatar repository (BAR) device.

In one example, a method of communicating augmented reality (AR) media data includes: obtaining data representing a base avatar and one or more avatar assets associated with an AR user, wherein the data indicates that a base avatar repository device stores the base avatar and the one or more assets; initiating an AR communication session including the user; and sending an access token to a client device associated with at least one other user involved in the AR communication session, the access token indicating that the at least one other user has access to the base avatar and a selection of the one or more avatar assets.

In another example, a device for communicating augmented reality (AR) media data includes: a memory configured to store media data; and a processing system implemented in circuitry and configured to: obtain data representing a base avatar and one or more avatar assets associated with an AR user, wherein the data indicates that a base avatar repository device stores the base avatar and the one or more assets; initiate an AR communication session including the user; and send an access token to a client device associated with at least one other user involved in the AR communication session, the access token indicating that the at least one other user has access to the base avatar and a selection of the one or more avatar assets.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example network including various devices for performing the techniques of this disclosure.

FIG. 2 is a block diagram illustrating an example computing system that may perform split rendering techniques.

FIG. 3 is a flow diagram illustrating an example avatar animation workflow that may be used during an augmented reality (AR) session.

FIG. 4 is a flow diagram illustrating an example AR session between two user equipment (UE) devices and a shared space server device.

FIG. 5 is a block diagram illustrating an example user equipment (UE) per techniques of this disclosure.

FIG. 6 is a block diagram illustrating an example set of devices that may perform various aspects of the techniques of this disclosure.

FIG. 7 is a conceptual diagram illustrating an example set of data that may be used in an AR session per techniques of this disclosure.

FIG. 8 is a block diagram illustrating an example system of devices that may perform techniques of this disclosure.

FIG. 9 is a call flow diagram illustrating an example method for establishing an AR communication session between two (or more) UEs, including accessing a base avatar from a base avatar repository (BAR) device per techniques of this disclosure.

FIG. 10 is a call flow diagram illustrating an example method that may be performed by two (or more) UEs engaged in an ongoing AR communication session, along with a base avatar repository (BAR) device per techniques of this disclosure.

FIG. 11 is a flowchart illustrating an example method of participating in an AR communication session per techniques of this disclosure.

FIG. 12 is a flowchart illustrating an example method of participating in an AR communication session per techniques of this disclosure.

### DETAILED DESCRIPTION

In general, this disclosure describes techniques for transporting and processing extended reality (XR) media data, such as augmented reality (AR) media data, mixed reality (MR) media data, or virtual reality (VR) media data. Immersive AR experiences are based on shared virtual spaces, where people (represented by avatars) join and interact with each other and the environment. Avatars may be realistic representations of the user or may be a “cartoonish” representation. Avatars may be animated to mimic the user's body pose and facial expressions.

A display device (or another device) may capture facial movements of the user. For example, the display device may include one or more cameras or other sensors for detecting facial expressions and/or movements of the user, e.g., smiling, neutral, frowning, or mouth and jaw movements that occur when the user speaks. The display device may encode data representative of such facial movements and send the encoded data to a receiving device, such that the receiving device can animate the user's avatar consistent with the user's facial movements.

A receiving device may render received AR media data. Such rendering may be performed on a single device or using split rendering. A split rendering server may perform at least part of a rendering process to form rendered images, then stream the rendered images to a display device, such as AR glasses or a head mounted display (HMTD). In general, a user may wear the display device, and the display device may capture pose information, such as a user position and orientation/rotation in real world space, which may be translated to render images for a viewport in a virtual world space.

Split rendering may enhance a user experience through providing access to advanced and sophisticated rendering that otherwise may not be possible or may place excess power and/or processing demands on AR glasses or a user equipment (UE) device. In split rendering all or parts of the three-dimensional (3D) scene are rendered remotely on an edge application server, also referred to as a “split rendering server” in this disclosure. The results of the split rendering process are streamed down to the UE or AR glasses for display. The spectrum of split rendering operations may be wide, ranging from full pre-rendering on the edge to offloading partial, processing-intensive rendering operations to the edge.

The display device (e.g., UE/AR glasses) may stream pose predictions to the split rendering server at the edge. The display device may then receive rendered media for display from the split rendering server. The AR runtime may be configured to receive rendered data together with associated pose information (e.g., information indicating the predicted pose for which the rendered data was rendered) for proper composition and display. For instance, the AR runtime may need to perform pose correction to modify the rendered data according to an actual pose of the user at the display time.

Immersive XR experiences, such as AR communication sessions, may use avatars to represent users in shared virtual spaces. Users may find it beneficial to manage, upload, update, or delete base avatars and associated digital assets directly on a base avatar repository (BAR), which may be used to send avatars and assets to others involved in AR communication sessions. Furthermore, conventional systems may not provide sufficient security mechanisms for authorizing specific participants in a communication session to access a selected base avatar and a specific subset of assets, potentially leading to unauthorized access or interoperability issues between devices with differing capabilities.

This disclosure describes techniques for management and authorization of base avatars for use during AR communication sessions. A BAR device may provide application programming interfaces (APIs) that enable a user equipment (UE) device to perform management operations, such as uploading, updating, and deleting base avatars and associated assets (e.g., clothing, accessories, or the like to be worn or used by the avatars).

During an AR communication session, the UE device generates an access token that authorizes one or more other participants in the session to access a specific base avatar and a selected set of assets stored on the BAR device for the AR communication session. The UE device sends the access token to the other participants, for example, within a Session Description Protocol (SDP) message. The other participants use the access token to request the base avatar and assets from the BAR device. The BAR device validates the token and provides the authorized content to the requesting participants. These techniques may therefore facilitate secure, user-controlled sharing of avatar assets and may support efficient negotiation of avatar capabilities and assets between devices, which may support compatibility and enhance the user experience in immersive AR communication sessions.

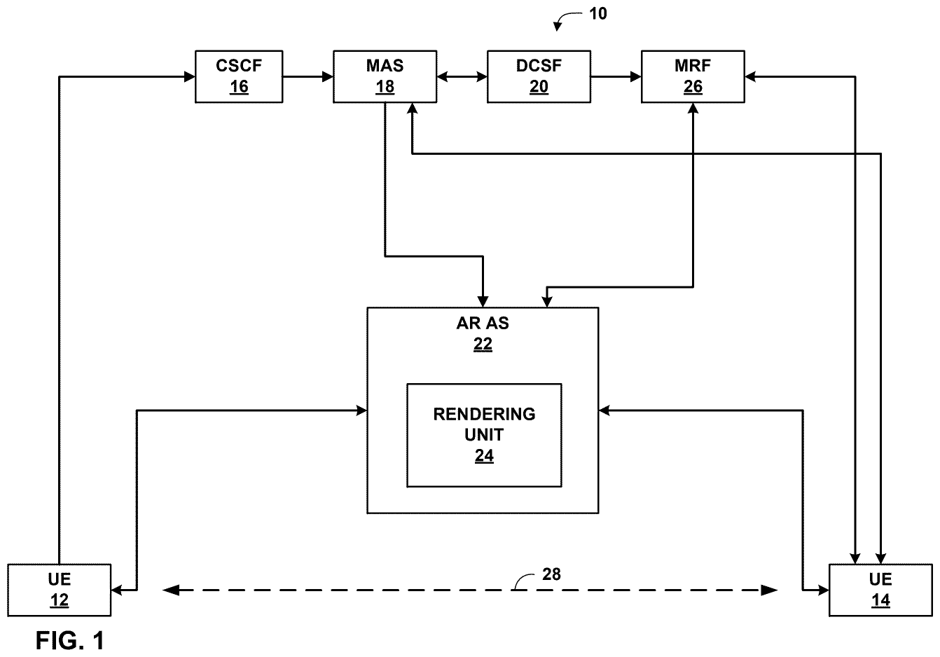

FIG. 1 is a block diagram illustrating an example network 10 including various devices for performing the techniques of this disclosure. In this example, network 10 includes user equipment (UE) devices 12, 14, call session control function (CSCF) 16, multimedia application server (MAS) 18, data channel signaling function (DCSF) 20, multimedia resource function (MRF) 26, and augmented reality application server (AR AS) 22. MAS 18 may correspond to a multimedia telephony application server, an IP Multimedia Subsystem (IMS) application server, or the like.

UEs 12, 14 represent examples of UEs that may participate in an AR communication session 28. AR communication session 28 may generally represent a communication session during which users of UEs 12, 14 exchange voice, video, and/or AR data (and/or other XR data). For example, AR communication session 28 may represent a conference call during which the users of UEs 12, 14 may be virtually present in a virtual conference room, which may include a virtual table, virtual chairs, a virtual screen or white board, or other such virtual objects. The users may be represented by avatars, which may be realistic or cartoonish depictions of the users in the virtual AR scene. The users may interact with virtual objects, which may cause the virtual objects to move or trigger other behaviors in the virtual scene. Furthermore, the users may navigate through the virtual scene, and a user's corresponding avatar may move according to the user's movements or movement inputs. In some examples, the users' avatars may include faces that are animated according to the facial movements of the users (e.g., to represent speech or emotions, e.g., smiling, thinking, frowning, or the like).

UEs 12, 14 may exchange AR media data related to a virtual scene, represented by a scene description. Users of UEs 12, 14 may view the virtual scene including virtual objects, as well as user AR data, such as avatars, shadows cast by the avatars, user virtual objects, user provided documents such as slides, images, videos, or the like, or other such data. Ultimately, users of UEs 12, 14 may experience an AR call from the perspective of their corresponding avatars (in first or third person) of virtual objects and avatars in the scene.

UEs 12, 14 may collect pose data for users of UEs 12, 14, respectively. For example, UEs 12, 14 may collect pose data including a position of the users, corresponding to positions within the virtual scene, as well as an orientation of a viewport, such as a direction in which the users are looking (i.e., an orientation of UEs 12, 14 in the real world, corresponding to virtual camera orientations). UEs 12, 14 may provide this pose data to AR AS 22 and/or to each other.

CSCF 16 may be a proxy CSCF (P-CSCF), an interrogating CSCF (I-CSCF), or serving CSCF (S-CSCF). CSCF 16 may generally authenticate users of UEs 12 and/or 14, inspect signaling for proper use, provide quality of service (QoS), provide policy enforcement, participate in Session Initiation Protocol (SIP) communications, provide session control, direct messages to appropriate application server(s), provide routing services, or the like. CSCF 16 may represent one or more I/S/P CSCFs.

MAS 18 represents an application server for providing voice, video, and other telephony services over a network, such as a 5G network. MAS 18 may provide telephony applications and multimedia functions to UEs 12, 14.

DCSF 20 may act as an interface between MAS 18 and MRF 26, to request data channel resources from MRF 26 and to confirm that data channel resources have been allocated. DCSF 20 may receive event reports from MAS 18 and determine whether an AR communication service is permitted to be present during a communication session (e.g., an IMS communication session).

MRF 26 may be an enhanced MRF (eMRF) in some examples. In general, MRF 26 generates scene descriptions for each participant in an AR communication session. MRF 26 may support an AR conversational service, e.g., including providing transcoding for terminals with limited capabilities. MRF 26 may collect spatial and media descriptions from UEs 12, 14 and create scene descriptions for symmetrical AR call experiences. In some examples, rendering unit 24 may be included in MRF 26 instead of AR AS 22, such that MRF 26 may provide remote AR rendering services, as discussed in greater detail below.

MRF 26 may request data from UEs 12, 14 to create a symmetric experience for users of UEs 12, 14. The requested data may include, for example, a spatial description of a space around UEs 12, 14; media properties representing AR media that each of UEs 12, 14 will be sending to be incorporated into the scene; receiving media capabilities of UEs 12, 14 (e.g., decoding and rendering/hardware capabilities, such as a display resolution); and information based on detecting location, orientation, and capabilities of physical world devices that may be used in an audio-visual communication session. Based on this data, MRF 26 may create a scene that defines placement of each user and AR media in the scene (e.g., position, size, depth from the user, anchor type, and recommended resolution/quality); and specific rendering properties for AR media data (e.g., if 2D media should be rendered with a “billboarding” effect such that the 2D media is always facing the user). MRF 26 may send the scene data to each of UEs 12, 14 using a supported scene description format.

AR AS 22 may participate in AR communication session 28. For example, AR AS 22 may provide AR service control related to AR communication session 28. AR service control may include AR session media control and AR media capability negotiation between UEs 12, 14 and rendering unit 24.

AR AS 22 also includes rendering unit 24, in this example. Rendering unit 24 may perform split rendering on behalf of at least one of UEs 12, 14. In some examples, two different rendering units may be provided. In general, rendering unit 24 may perform a first set of rendering tasks for, e.g., UE 14, and UE 14 may complete the rendering process, which may include warping rendered viewport data to correspond to a current view of a user of UE 14. For example, UE 14 may send a predicted pose (position and orientation) of the user to rendering unit 24, and rendering unit 24 may render a viewport according to the predicted pose. However, if the actual pose is different than the predicted pose at the time video data is to be presented to a user of UE 14, UE 14 may warp the rendered data to represent the actual pose (e.g., if the user has suddenly changed movement direction or turned their head).

While only a single rendering unit is shown in the example of FIG. 1, in other examples, each of UEs 12, 14 may be associated with a corresponding rendering unit. Rendering unit 24 as shown in the example of FIG. 1 is included in AR AS 22, which may be an edge server at an edge of a communication network. However, in other examples, rendering unit 24 may be included in a local network of, e.g., UE 12 or UE 14. For example, rendering unit 24 may be included in a PC, laptop, tablet, or cellular phone of a user, and UE 14 may correspond to a wireless display device, e.g., AR/VR/MR/XR glasses or head mounted display (HMD). Although two UEs are shown in the example of FIG. 1, in general, multi-participant AR calls are also possible.

UEs 12, 14, and AR AS 22 may communicate AR data using a network communication protocol, such as Real-time Transport Protocol (RTP), which is standardized in Request for Comment (RFC) 3550 by the Internet Engineering Task Force (IETF). These and other devices involved in RTP communications may also implement protocols related to RTP, such as RTP Control Protocol (RTCP), Real-time Streaming Protocol (RTSP), Session Initiation Protocol (SIP), and/or Session Description Protocol (SDP).

In general, an RTP session may be established as follows. UE 12, for example, may receive an RTSP describe request from, e.g., UE 14. The RTSP describe request may include data indicating what types of data are supported by UE 14. UE 12 may respond to UE 14 with data indicating media streams that can be sent to UE 14, along with a corresponding network location identifier, such as a uniform resource locator (URL) or uniform resource name (URN).

UE 12 may then receive an RTSP setup request from UE 14. The RTSP setup request may generally indicate how a media stream is to be transported. The RTSP setup request may contain the network location identifier for the requested media data and a transport specifier, such as local ports for receiving RTP data and control data (e.g., RTCP data) on UE 14. UE 12 may reply to the RTSP setup request with a confirmation and data representing ports of UE 12 by which the RTP data and control data will be sent. UE 12 may then receive an RTSP play request, to cause the media stream to be “played,” i.e., sent to UE 14. UE 12 may also receive an RTSP teardown request to end the streaming session, in response to which, UE 12 may stop sending media data to UE 14 for the corresponding session.

UE 14, likewise, may initiate a media stream by initially sending an RTSP describe request to UE 12. The RTSP describe request may indicate types of data supported by UE 14. UE 14 may then receive a reply from UE 12 specifying available media streams that can be sent to UE 14, along with a corresponding network location identifier, such as a uniform resource locator (URL) or uniform resource name (URN).

UE 14 may then generate an RTSP setup request and send the RTSP setup request to UE 12. As noted above, the RTSP setup request may contain the network location identifier for the requested media data and a transport specifier, such as local ports for receiving RTP data and control data (e.g., RTCP data) on UE 14. In response, UE 14 may receive a confirmation from UE 12, including ports of UE 12 that UE 12 will use to send media data and control data.

After establishing a media streaming session (e.g., AR communication session 28) between UE 12 and UE 14, UE 12 exchanges media data (e.g., packets of media data) with UE 14 according to the media streaming session. UE 12 and UE 14 may exchange control data (e.g., RTCP data) indicating, for example, reception statistics by UE 14, such that UEs 12, 14 can perform congestion control or otherwise diagnose and address transmission faults.

By utilizing a base avatar repository (BAR) device to store base avatars and assets, and controlling access via access tokens generated by UE 12, the system of FIG. 1 may effectively manage secure access to user-specific digital assets. This configuration may address the technical challenge of unauthorized retrieval of personalized avatars in shared virtual spaces. For example, the generation and distribution of access tokens by UE 12 may allow for granular, session-specific authorization, which may restrict access such that only authorized participants, such as UE 14, can retrieve the base avatar data from the BAR device associated with the user of UE 12.

Furthermore, the disclosed management API may enable efficient lifecycle management of avatar assets. By allowing UE 12 to upload, update, or delete specific assets on the BAR device, the system of FIG. 1 may avoid the need to repeatedly transmit unrestricted or full avatar models during call setup. This arrangement may reduce bandwidth consumption and setup latency for AR communication session 28, as receiving devices, such as UE 14, can retrieve only the selected and authorized assets directly from the BAR device using the provided access token.

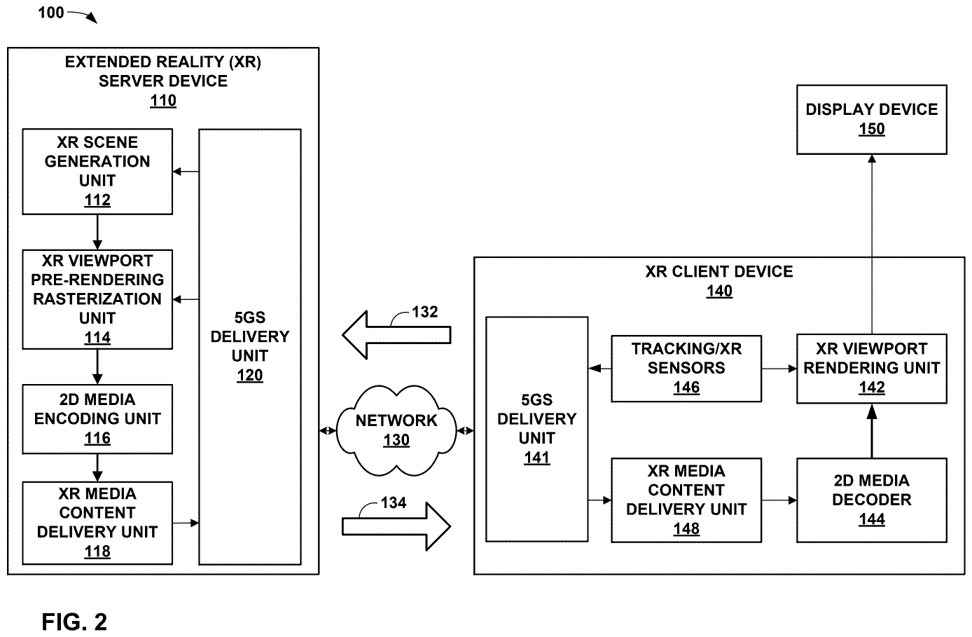

FIG. 2 is a block diagram illustrating an example computing system 100 that may perform split rendering techniques. In this example, computing system 100 includes extended reality (XR) server device 110, network 130, XR client device 140, and display device 150. XR server device 110 includes XR scene generation unit 112, XR viewport pre-rendering rasterization unit 114, 2D media encoding unit 116, XR media content delivery unit 118, and 5G System (5GS) delivery unit 120.

Network 130 may correspond to any network of computing devices that communicate according to one or more network protocols, such as the Internet. In particular, network 130 may include a 5G radio access network (RAN) including an access device to which XR client device 140 connects to access network 130 and XR server device 110. In other examples, other types of networks, such as other types of RANs, may be used. For example, network 130 may represent a wireless or wired local network. In other examples, XR client device 140 and XR server device 110 may communicate via other mechanisms, such as Bluetooth, a wired universal serial bus (USB) connection, or the like. XR client device 140 includes 5GS delivery unit 141, tracking/XR sensors 146, XR viewport rendering unit 142, 2D media decoder 144, and XR media content delivery unit 148. XR client device 140 also interfaces with display device 150 to present XR media data to a user (not shown).

In some examples, XR scene generation unit 112 may correspond to an interactive media entertainment application, such as a video game, which may be executed by one or more processors implemented in circuitry of XR server device 110. XR viewport pre-rendering rasterization unit 114 may format scene data generated by XR scene generation unit 112 as pre-rendered two-dimensional (2D) media data (e.g., video data) for a viewport of a user of XR client device 140. 2D media encoding unit 116 may encode formatted scene data from XR viewport pre-rendering rasterization unit 114, e.g., using a video encoding standard, such as ITU-T H.264/Advanced Video Coding (AVC), ITU-T H.265/High Efficiency Video Coding (HEVC), ITU-T H.266 Versatile Video Coding (VVC), or the like. XR media content delivery unit 118 represents a content delivery sender, in this example. In this example, XR media content delivery unit 148 represents a content delivery receiver, and 2D media decoder 144 may perform error handling.

In accordance with techniques of this disclosure, XR server device 110 (e.g., acting as a media function device) may obtain data representing a base avatar and one or more avatar assets associated with an AR user. For example, a user of a peer device (not shown in FIG. 2) participating in an AR communication session with a user of XR client device 140 may provide data indicating that a base avatar repository device (e.g., connected to network 130) stores the base avatar and the one or more assets. XR server device 110 may receive an access token from the peer device (or XR client device 140 acting as a relay). The access token may indicate that the at least one other user (e.g., XR server device 110 acting on behalf of XR client device 140) has access to the base avatar and a selection of the one or more avatar assets. XR server device 110 may send a request to the base avatar repository device to access the base avatar, the request including the access token. Upon retrieving the base avatar and assets, XR scene generation unit 112 may animate the base avatar based on an animation stream received from the peer device and include the animated avatar in the scene data generated for XR client device 140.

In general, XR client device 140 may determine a user's viewport, e.g., a direction in which a user is looking and a physical location of the user, which may correspond to an orientation of XR client device 140 and a geographic position of XR client device 140. Tracking/XR sensors 146 may determine such location and orientation data, e.g., using cameras, accelerometers, magnetometers, gyroscopes, or the like. Tracking/XR sensors 146 provide location and orientation data to XR viewport rendering unit 142 and 5GS delivery unit 141. XR client device 140 provides tracking and sensor information 132 to XR server device 110 via network 130. XR server device 110, in turn, receives tracking and sensor information 132 and provides this information to XR scene generation unit 112 and XR viewport pre-rendering rasterization unit 114. In this manner, XR scene generation unit 112 can generate scene data for the user's viewport and location, and then pre-render 2D media data for the user's viewport using XR viewport pre-rendering rasterization unit 114. XR server device 110 may therefore deliver encoded, pre-rendered 2D media data 134 to XR client device 140 via network 130, e.g., using a 5G radio configuration.

XR scene generation unit 112 may receive data representing a type of multimedia application (e.g., a type of video game), a state of the application, multiple user actions, or the like. XR viewport pre-rendering rasterization unit 114 may format a rasterized video signal. 2D media encoding unit 116 may be configured with a particular encoder/decoder (codec), bitrate for media encoding, a rate control algorithm and corresponding parameters, data for forming slices of pictures of the video data, low latency encoding parameters, error resilience parameters, intra-prediction parameters, or the like. XR media content delivery unit 118 may be configured with real-time transport protocol (RTP) parameters, rate control parameters, error resilience information, and the like. XR media content delivery unit 148 may be configured with feedback parameters, error concealment algorithms and parameters, post correction algorithms and parameters, and the like.

Raster-based split rendering refers to the case where XR server device 110 runs an XR engine (e.g., XR scene generation unit 112) to generate an XR scene based on information coming from an XR device, e.g., XR client device 140 and tracking and sensor information 132. XR server device 110 may rasterize an XR viewport and perform XR pre-rendering using XR viewport pre-rendering rasterization unit 114.

In the example of FIG. 2, the viewport is predominantly rendered in XR server device 110, but XR client device 140 is able to do latest pose correction, for example, using asynchronous time-warping or other XR pose correction to address changes in the pose. XR graphics workload may be split into rendering workload on a powerful XR server device 110 (in the cloud or the edge) and pose correction (such as asynchronous timewarp (ATW)) on XR client device 140. Low motion-to-photon latency is preserved via on-device Asynchronous Time Warping (ATW) or other pose correction methods performed by XR client device 140.

The various components of XR server device 110, XR client device 140, and display device 150 may be implemented using one or more processors implemented in circuitry, such as one or more digital signal processors (DSPs), general purpose microprocessors, application specific integrated circuits (ASICs), field programmable logic arrays (FPGAs), or other equivalent integrated or discrete logic circuitry. The functions attributed to these various components may be implemented in hardware, software, or firmware. When implemented in software or firmware, it should be understood that instructions for the software or firmware may be stored on a computer-readable medium and executed by requisite hardware.

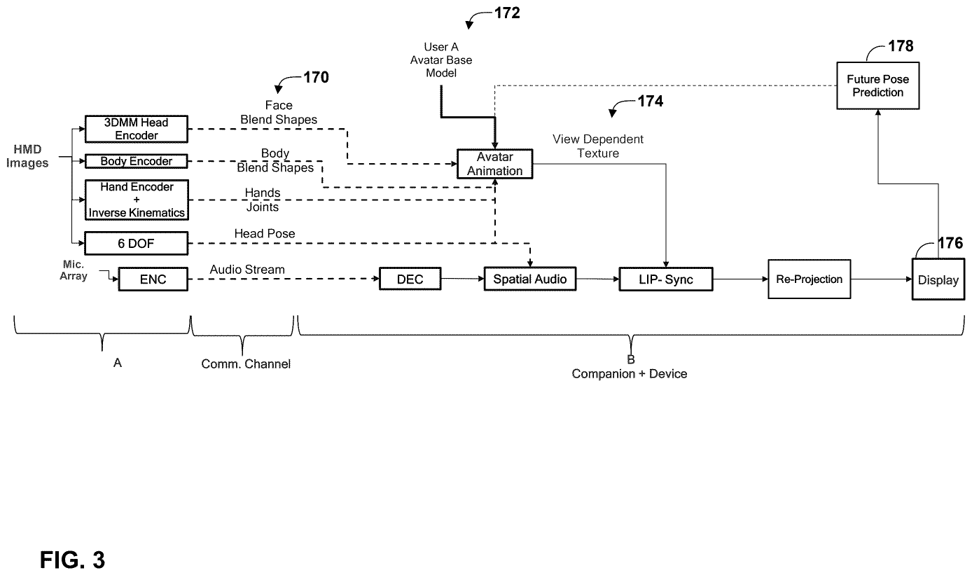

FIG. 3 is a flow diagram illustrating an example avatar animation workflow that may be used during an AR session. In this example, received animation stream data 170 includes face blendshapes, body blendshapes, hand joints, head pose, and audio stream data. The face blendshapes, body blendshapes, and hand joints may correspond to animation streams to be applied to user A avatar base model 172. In particular, data for user A avatar base model 172 may be stored at various levels of detail, per the techniques of this disclosure. Thus, rendering components 174 may retrieve data of user A avatar base model 172 at an appropriate level of detail, e.g., based on a distance between a current user and user A in a 3D space. Rendering components 174 may then animate the avatar base model using received animation stream data 170. Ultimately, the animated avatar base model may be presented to the current user via display 176. In addition, movement data of the current user may be used to predict a future pose of the user by future pose prediction unit 178.

In some examples, the device performing the workflow of FIG. 3 attributed to rendering components 174 corresponds to a client device associated with a first user (e.g., the current user) involved in an AR communication session with a second user (e.g., User A). The client device may receive an access token from a device associated with User A. The client device may send a request including the access token to a base avatar repository device to access User A avatar base model 172. The base avatar repository device stores User A avatar base model 172 and one or more avatar assets. In response to the request, the client device receives User A avatar base model 172. The client device also receives animation stream data 170, which corresponds to an animation stream for User A avatar base model 172. Rendering components 174 present an animated version of User A avatar base model 172 via display 176 according to the animation stream.

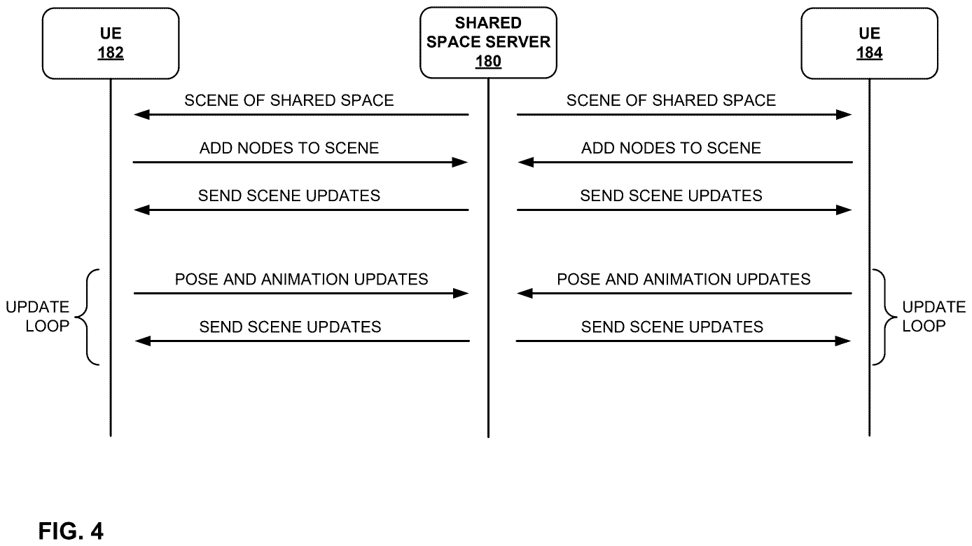

FIG. 4 is a flow diagram illustrating an example AR session between two user equipment (UE) devices and a shared space server device. As shown in the example of FIG. 4, two or more UEs may participate in an AR session. The UEs may send and receive data representative of their animation streams and other 3D model data to and from a shared space server. For example, various sensors such as cameras, trackers, Light Detection and Ranging (LIDAR), or the like, may track user movements, such as facial movements (e.g., during speech or as emotional reactions), hand movements, walking movements, or the like. These movements may be translated into an animation stream by, e.g., UE 182 and sent to the shared space server. The shared space server may then send the animation stream to UE 184.

In accordance with the techniques of this disclosure, prior to or during the AR session depicted in FIG. 4, UE 182 may perform authorization procedures for a base avatar. For instance, UE 182 may obtain data representing a base avatar and one or more avatar assets associated with a user of UE 182. This data indicates that a base avatar repository device (which may be separate from or integrated with shared space server 180) stores the base avatar and the one or more assets. UE 182 may generate an access token for a user of UE 184 involved in the AR communication session. This access token indicates that the user of UE 184 has access to the base avatar and a selection of the one or more avatar assets. UE 182 may send the access token to UE 184, potentially via shared space server 180 (e.g., within an SDP offer or other signaling message). UE 184 may then use the access token to retrieve the base avatar from the base avatar repository device. Consequently, when shared space server 180 sends the animation stream to UE 184 as shown in FIG. 4, UE 184 uses the received animation stream to animate the base avatar retrieved using the access token, thereby presenting an animated version of the base avatar associated with the user of UE 182.

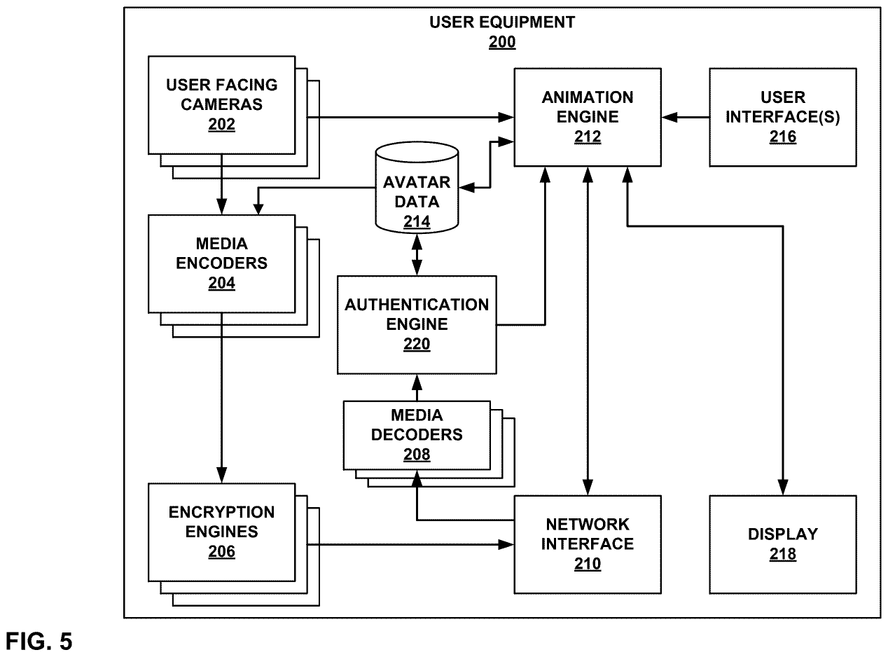

FIG. 5 is a block diagram illustrating an example user equipment (UE) 200. UEs 12, 14 of FIG. 1 may include components similar to those of UE 200. In general, a participant device may both send and receive content during an AR communication session. In this example, UE 200 includes user facing cameras 202, media encoders 204, encryption engines 206, media decoders 208, network interface 210, authentication engine 220, avatar data 214, animation engine 212, user interface(s) 216, and display 218.

A user may use UE 200 to participate in an AR communication session, e.g., to both send and receive AR data with one or more other participants in the AR communication session. For example, UE 200 may receive inputs from the user via user interface(s) 216, which may correspond to buttons, controllers, track pads, joysticks, keyboards, sensors, or the like. Such inputs may represent, for example, movements of the user in real-world space to be translated into the virtual scene, such as locomotive movement, head movements, eye movements (captured by user facing cameras 202), or interactions with the various buttons or other interface devices.

Animation engine 212 may receive such inputs and determine how to animate a user's avatar, stored in avatar data 214. For example, such animations may include locomotive animations (walking or running), arm movement animations, hand movement animations, finger movement animations, and/or facial expression change animations. Animation engine 212 may provide animation information to network interface 210 for output to other participants in the AR communication session, along with other information such as, for example, interactions with virtual objects, movement direction, viewport, or the like.

In addition, per the techniques of this disclosure, user facing cameras 202 may provide one or more video streams of a user's face to media encoder(s) 204 to form an encoded video stream, which may be encrypted by encryption engine(s) 206 or sent unencrypted. That is, one or more video streams capturing distinguishing features of the user's face or other objects of interest (e.g., background objects, location-identifying objects, unique identifiers, or the like) may be sent via network interface 210 to one or more other participants in the AR communication session. When the user is wearing a head-mounted display (HMD), the HMD may be configured to capture specific parts of the user's face by user-facing cameras 202 of the HMD (e.g., eyes and mouth may be captured as three distinct streams). Such video streams (which may further be encrypted) may be provided to network interface 210 and sent to other participants in the AR communication session, such that the UEs of the other participants can authenticate that the avatar data is actually coming from the user of UE 200, per the techniques of this disclosure. In general, the distinguishing features may be any one or more elements of a person, location, object, or the like that may be used to uniquely identify the target person, location, or object and to associate the avatar (or other 3D object) with the target person, location, or object.

Similarly, UE 200 may receive encrypted video stream(s) from the other participants in the AR communication session. UE 200 may decrypt and then decode the video stream(s) using media decoders 208, which may provide the decrypted video streams to authentication engine 220. Per the techniques of this disclosure, authentication engine 220 may compare data of the received video streams to authentication data associated with an avatar of the other user being authenticated, stored with avatar data 214.

As an example, authentication engine 220 may include a deep learning algorithm, e.g., an artificial intelligence/machine learning (AI/ML) model trained to extract facial features. The facial features may be a vector of values, e.g., 568 values, that provide a latent representation of a face. Distances to the facial features may be stored in the base avatar model as part of avatar data 214. Authentication engine 220 may calculate distances between facial features extracted from the received video bitstream(s) and compare these distances to the distances stored as part of avatar data 214, to determine if the user's face is the same as that of the user associated with the avatar. In addition to, or in the alternative to, facial features, other features may be used, such as 3D head features, vocal features, and/or light environments.

The avatar may be stored by a base avatar repository (not shown in FIG. 5). UE 200 may send the access token and data representing a URL of the base avatar repository to a peer UE involved in an AR communication session with UE 200 to grant permission to the peer UE to retrieve the avatar from the base avatar repository. UE 200 may then send an animation stream to the peer UE to cause the peer UE to animate the base avatar. UE 200 may also receive an access token for an avatar for a user of the peer UE, and use the access token to retrieve the avatar for the user of the peer UE. UE 200 may then receive an animation stream from the peer UE and animate the avatar for the user of the peer UE using the received animation stream.

In accordance with the techniques of this disclosure, UE 200 represents a device for communicating augmented reality (AR) media data. UE 200 includes avatar data 214, representing a memory configured to store media data, and various components such as media encoders 204, encryption engines 206, authentication engine 220, media decoders 208, animation engine 212, user interfaces 216, and network interface 210, which collectively represent a processing system including one or more processors implemented in circuitry. UE 200 may obtain data indicating a base avatar repository device that stores a base avatar and one or more avatar assets associated with an AR user of a peer UE. UE 200 may also receive an access token, which may be digitally signed using a private key of the AR user of the peer UE. When signed, UE 200 may execute encryption engines 206 to decrypt (i.e., verify a digital signature of) a hash of the access token using the public key of the AR user of the peer UE, calculate a hash of the access token, and compare the decrypted hash to the calculated hash to verify that the access token originated from the AR user of the peer UE. In some examples, the access token itself may be signed, rather than a hash of the access token. UE 200 may then use the access token to request and retrieve the base avatar and the assets from the base avatar repository.

UE 200 may also form its own access token for accessing a base avatar of a user of UE 200. UE 200 may initiate an AR communication session including the AR user of the peer UE. UE 200 may generate the access token for the AR user of the peer UE, indicating that the AR user of the peer UE is authorized to access the base avatar and a selection of the one or more avatar assets. UE 200 sends the access token to the peer UE (e.g., another client device) associated with the AR user of the peer UE.

UE 200 may also enable user management of the avatar assets. UE 200 may obtain at least one new avatar asset for the base avatar, e.g., from the user of UE 200, from a digital marketplace, or the like. UE 200 may send data representing the at least one new avatar asset to the base avatar repository device. UE 200 may also request deletion of at least one avatar asset associated with the base avatar or deletion of the base avatar itself.

The access token generated by UE 200 may provide granular control. The access token may include data representing one or more of a session identification associated with the AR communication session, an identifier of the at least one other user, a time during which the access to the base avatar is permitted, an identifier associated with the base avatar, a list of asset identifiers used to compose the base avatar, or permitted levels of detail associated with assets corresponding to the list of asset identifiers.

In this manner, UE 200 represents an example of a device for communicating augmented reality (AR) media data, including: a memory configured to store media data; and a processing system implemented in circuitry and configured to: obtain data representing a base avatar and one or more avatar assets associated with an AR user, wherein the data indicates that a base avatar repository device stores the base avatar and the one or more assets; initiate an AR communication session including the user; and send an access token to a client device associated with at least one other user involved in the AR communication session, the access token indicating that the at least one other user has access to the base avatar and a selection of the one or more avatar assets.

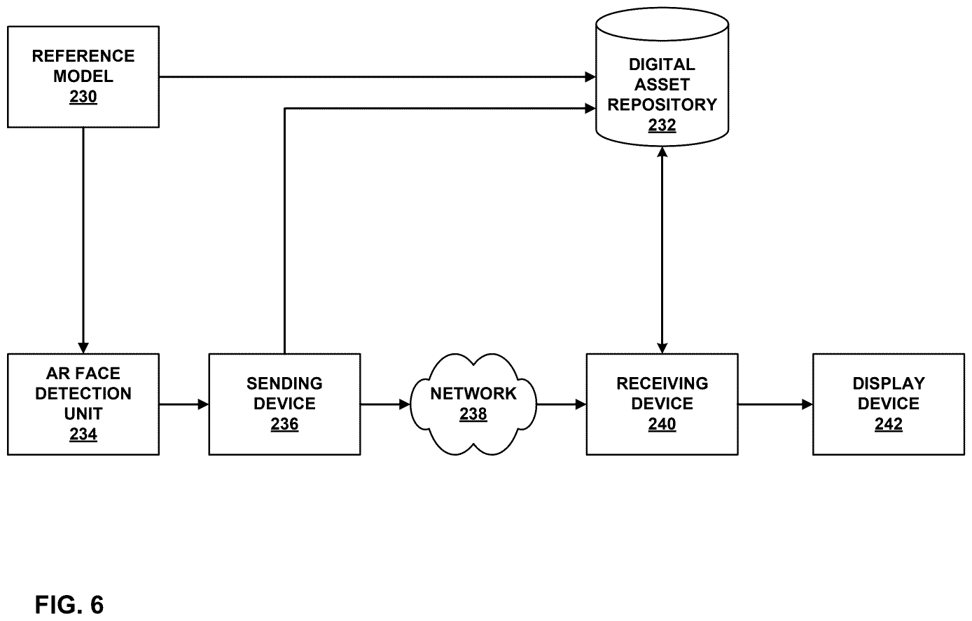

FIG. 6 is a block diagram illustrating an example set of devices that may perform various aspects of the techniques of this disclosure. The example of FIG. 6 depicts reference model 230, digital asset repository 232, AR face detection unit 234, sending device 236, network 238, receiving device 240, and display device 242. Sending device 236 may correspond to UE 12 of FIG. 1, and receiving device 240 may correspond to UE 14 of FIG. 1 and/or XR client device 140 of FIG. 2.

Sending device 236 and receiving device 240 may represent user equipment (UE) devices, such as smartphones, tablets, laptop computers, personal computers, or the like. AR face detection unit 234 may be included in an AR display device, such as an AR headset, which may be communicatively coupled to sending device 236. Likewise, display device 242 may be an AR display device, such as an AR headset.

In this example, reference model 230 includes model data for a human body and face. Digital asset repository 232 (which may also be referred to as a “base avatar repository” or “BAR device”) may include avatar data for a user, e.g., a user of sending device 236. Digital asset repository 232 may store the avatar data in a base avatar format. The base avatar format may differ based on software used to form the base avatar, e.g., modeling software from various vendors.

AR face detection unit 234 may detect facial expressions of a user and provide data representative of the facial expressions to sending device 236. Sending device 236 may encode the facial expression data and send the encoded facial expression data to receiving device 240 via network 238. Network 238 may represent the Internet or a private network (e.g., a virtual private network (VPN)). Receiving device 240 may decode and reconstruct the facial expression data and use the facial expression data to animate the avatar of the user of sending device 236.

Various facial and body tracking units may perform facial and body tracking in different ways, which may vary widely according to a solution being sought. For example, various facial and body tracking units may be configured with different numbers of blendshapes with different sets of expressions and/or different rigs (that is, 3D models of joints and bones) with different sets of bones and joints and different bone dimension. Some facial expressions and bones/joints do not exist in certain solutions but do exist in other solutions.

This variation in 3D object model representations can lead to interoperability challenges. For example, sending device 236 may use a first framework to track face and body movements of a user, while receiving device 240 may use a base avatar of the user of sending device 236 that is based on a different set of facial expressions and body skeleton. This disclosure describes techniques for enabling avatar animation when different tracking frameworks are used for the base model and movement tracking.

In accordance with the techniques of this disclosure, sending device 236 may obtain data representing a base avatar and one or more avatar assets associated with a user of sending device 236. The data indicates that digital asset repository 232 stores the base avatar and the one or more assets. For example, sending device 236 may upload the base avatar and the one or more avatar assets to digital asset repository 232, then generate the data indicating that digital asset repository 232 stores the base avatar and a selection of the assets. Sending device 236 may initiate an AR communication session including the user. Sending device 236 may generate an access token for at least one other user involved in the AR communication session indicating that the at least one other user has access to the base avatar and a selection of the one or more avatar assets, such as a user of receiving device 240. Sending device 236 may send the access token to receiving device 240 associated with the at least one other user.

Receiving device 240 may receive the access token from sending device 236. Receiving device 240 may send a request to access the base avatar to digital asset repository 232, the request including the access token. Receiving device 240 may receive the base avatar associated with the user of sending device 236. Receiving device 240 may subsequently receive an animation stream for the base avatar associated with the user of sending device 236 from sending device 236. Receiving device 240 may then render the base avatar and the received assets according to the animation stream to generate an animated version of the base avatar associated with the user of sending device 236, and present the animation to the user of receiving device 240.

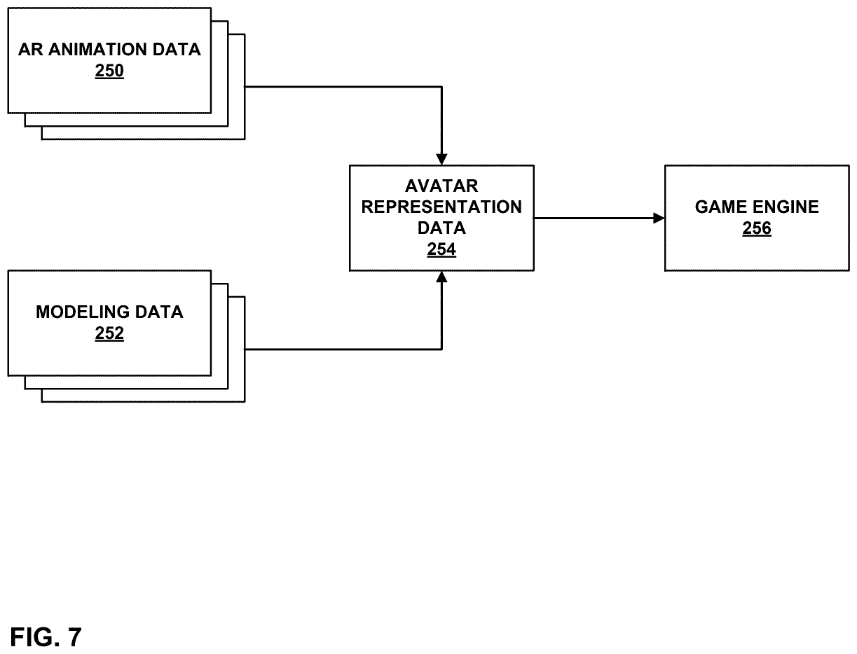

FIG. 7 is a conceptual diagram illustrating an example set of data that may be used in an AR session per techniques of this disclosure. In this example, FIG. 7 depicts AR animation data 250, modeling data 252, avatar representation data 254, and game engine 256. Modeling data 252 may represent one or more sets of data used to form a base avatar model, which may originate from various sources, such as modeling software (e.g., Blender or Maya), GL Transmission Format (glTF), universal scene description (USD), VRM Consortium, MetaHuman, or the like. AR animation data 250 may represent one or more tracked movements of a user to be used to animate the base model, which may originate from OpenXR, ARKit, MediaPipe, or the like. The combination of the base model and the animation data may be formed into avatar representation data 254, which game engine 256 may use to display an animated avatar. Game engine 256 may represent Unreal Engine, Unity Engine, Godot Engine, Third Generation Partnership Project (3GPP), or the like.

In accordance with the techniques of this disclosure, modeling data 252 may correspond to a base avatar and one or more avatar assets associated with an AR user. A base avatar repository device may store modeling data 252. A user device may generate an access token for at least one other user involved in an AR communication session. The access token may indicate that the at least one other user has access to the base avatar and a selection of the one or more avatar assets included in modeling data 252. The user device may send the access token to a client device associated with the at least one other user. Upon receiving the access token, the client device may retrieve the authorized portion of modeling data 252 from the base avatar repository device to form avatar representation data 254. Game engine 256 may then render the animated version of the base avatar using avatar representation data 254 and AR animation data 250 received as an animation stream.

By separating modeling data 252 (e.g., the base avatar and assets) from AR animation data 250, the system may improve network resource utilization. Static modeling data 252 may be retrieved from a repository or cache once, while AR animation data 250 may be received over the real-time communication channel. This architecture may reduce bandwidth consumption during the AR communication session and may lower latency for animation synchronization, enabling higher fidelity avatar representations without burdening the real-time stream.

Furthermore, the use of access tokens to control retrieval of modeling data 252 may enhance security and asset management. The system may allow a user to grant permission for specific assets (e.g., a subset of modeling data 252) to specific participants for the duration of a session. This granular authorization may prevent unauthorized access to a user's entire library of digital assets while facilitating the interoperable exchange of the relevant avatar components for the AR communication session.

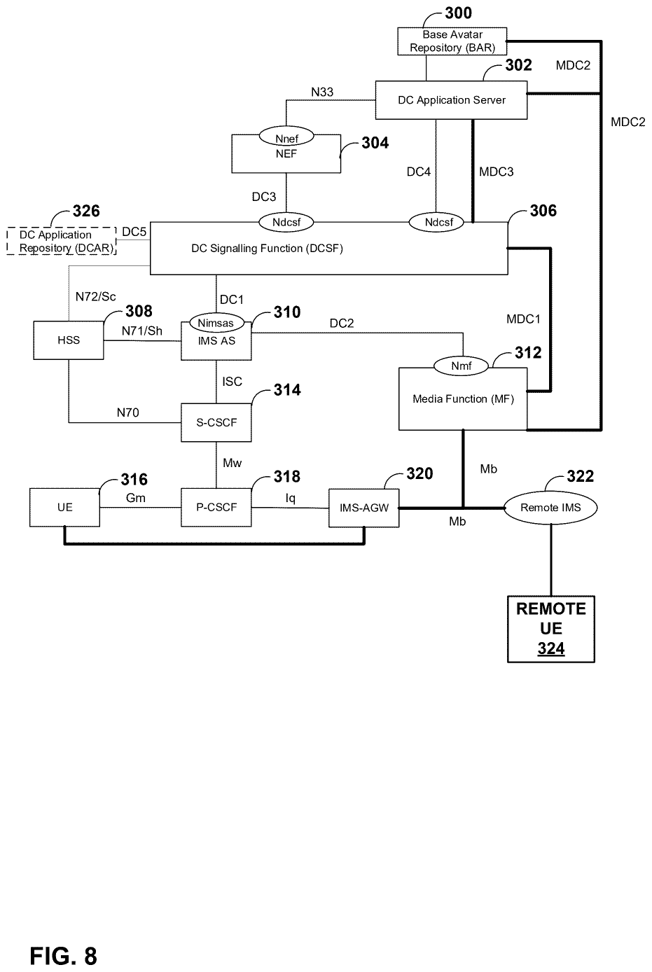

FIG. 8 is a block diagram illustrating an example system of devices that may perform techniques of this disclosure. In the example of FIG. 8, the system includes base avatar repository (BAR) device 300, data channel (DC) application server 302, network exposure function 304, DC signaling function 306, home subscriber server (HSS) 308, IP Multimedia Subsystem application server (IMS AS) 310, media function (MF) device 312, serving call session control function (S-CSCF) 314, user equipment (UE) device 316, proxy CSCF (P-CSCF) 318, IMS-access gateway (IMS-AGW) 320, remote IMS 322, remote UE 324, and DC application repository (DCAR) 326. UE device 316 may engage in an AR communication session with remote UE device 324 associated with a different user and that is communicatively coupled to remote IMS 322.

BAR device 300 stores avatar representations of one or more users. The avatar representations may be stored in avatar representation format (ARF) containers associated with avatar identifiers. BAR device 300 may provide a list of avatar identifiers to the DC AS device. BAR device 300 may also provide the base avatar to the MF device.

Communication between BAR device 300 and the various network entities may occur via specific reference points or interfaces as illustrated in FIG. 8. For instance, the exchange of avatar identifiers and management signaling between BAR device 300 and DC AS device 302 may occur via an interface labeled DC4. Similarly, the provision of the heavy media data, such as the base avatar container, from BAR device 300 to MF device 312 may occur via a media delivery interface, such as the interface labeled MDC2. MF device 312 may subsequently distribute the media data to UE device 316 and to remote UE 324 via interfaces as shown in FIG. 8. These interfaces may ensure that control signaling and media transport are handled efficiently within the IMS architecture.

BAR device 300 may execute a BAR function that provides a comprehensive RESTful API for avatar management in the IMS system. This API enables UE 316 to perform various operations related to avatar creation, modification, and sharing. BAR device 300 supports the Avatar Representation Format (ARF) container format and implements secure access control through token-based authorization. BAR device 300 function may allow users to create and manage base avatars, which may serve as foundations for avatar representation in IMS-based AR calls. Each base avatar may contain components, including head, body, hands, eyes, skeleton, joints, and blendshapes, for the avatar. These components form the core structure upon which additional avatar assets, such as garments and other digital assets, can be added or removed. Users can enhance their base avatars through asset management operations. Assets typically include skins that are posed on the skeleton and may be provided with all necessary components, including skin weights and meshes. The system may support multiple levels of detail (LOD) for assets, allowing for optimization based on different usage scenarios.

Table 1 below depicts an example set of create, read, update, and delete (CRUD) operations that may be offered for management of user base avatars. The operations described in Table 1 may further support the management of specific levels of detail (LOD) for the avatar assets. For example, the “Update Avatar” or “Add Asset” operations may allow UE 316 to add or remove specific LODs associated with an asset (e.g., adding a high-definition texture or removing a low-polygon mesh) to enable the receiving device to present the avatar at different levels of detail, e.g., based on a distance between the user of the receiving device in the virtual scene and the user associated with the avatar.

TABLE 1

| | HTTP | | |
|---|---|---|---|
| Operation | Method | Endpoint | Description |
| Create Avatar | POST | /avatars | Creates a new base avatar. |
| Get Avatar | GET | /avatars/{avatarId} | Retrieves a specific avatar. |
| Update Avatar | PUT | /avatars/{avatarId} | Updates an existing avatar. |
| Delete Avatar | DELETE | /avatars/{avatarId} | Removes an avatar. |
| Add Asset | POST | /avatars/{avatarId}/ | Adds a new asset to an avatar. The |
| | | assets | content of the post shall be a |
| | | | multi-part MIME with all the |
| | | | components of an asset. |
| Remove Asset | DELETE | /avatars/{avatarId}/ | Removes an asset from an avatar. |
| | | assets/{assetId} | |
| Generate | POST | /avatars/{avatarId}/ | Creates a new access token. |
| Token | | token | |

MF device 312 may relay an avatar identifier list via an application data channel or bootstrap data channel to remote UE device 324. MF device 312 may also relay the base avatar for either user to the remote and/or local UE device(s). MF device 312 may support avatar-related media processing, such as avatar animation. That is, as discussed above, MF device 312 and UE device 316 may engage in split rendering of the base avatar, including animating and rendering the base avatar using an animation stream, e.g., as discussed above with respect to FIGS. 1 and 2.

DC AS device 302 may support avatar media negotiations, e.g., between UE device 316, remote UE device 324, and/or with BAR device 300. In some examples, where split rendering/animation is performed, DC AS device 302 may instruct MF device 312 to perform avatar media processing.

The techniques of this disclosure may allow UE device 316 to modify (add, edit, or delete) avatar assets associated with a base avatar stored by BAR device 300. For example, a user of UE device 316 may upload, modify, or delete base avatars to/from BAR device 300. The user of UE device 316 may also modify (add, modify, or delete) avatar assets associated with one or more base avatars associated with the user. These techniques may further enable BAR device 300 to engage in negotiation for avatar assets to be used during an AR communication session. For example, BAR device 300 may determine whether other participants in the AR communication session are authorized to use a selected base avatar and related assets, and UEs may use these techniques to exchange authorization data to enable authorization to retrieve avatar data and assets for an AR communication session.

By integrating these management and authorization functions directly into the IMS architecture, the system offers a standardized telephony service for avatar communication. Unlike over-the-top (OTT) applications that manage avatars within closed, proprietary ecosystems, the disclosed techniques may enable interoperable avatar telepresence across different service providers and device manufacturers. This operator-level integration may ensure that avatar assets are managed as part of the telecommunication service profile rather than being isolated within a specific application.

In this manner, the techniques of this disclosure include management of base avatar assets, e.g., for use in an AR communication session. BAR device 300 may offer an application programming interface (API) for creating, reading, uploading, updating, and deleting base avatars associated with a user, as well as avatar assets for the base avatars. A user may retrieve a list of their base avatars from BAR device 300 via the API. For each avatar, the user may retrieve a list of assets and associated thumbnail images of the assets. The user may add or delete assets for a selected base avatar via the API. When an AR communication session begins and the user wants to offer an avatar to be presented during the AR communication session, the user may generate an access token either for all participants in the AR communication session or specifically for each participant of the AR communication session. The user may send the access token(s) to the other participants, such that the other participants can send the access token to BAR device 300 along with a request to retrieve the avatar data and assets. The access token may be encrypted or signed with a private key of the user associated with the avatar, such that BAR device 300 can decrypt or determine that the avatar data is actually associated with the user and that the user has granted access to the avatar and assets. Thus, BAR device 300 may generate a base avatar container and respond to remote UEs with the base avatar and authorized assets.

To facilitate this management, the user interface of the UE may present a visual customization environment. For example, the user may view a rendered version of the base avatar alongside a palette of available assets, such as garments (e.g., pullovers, hats, pants) or accessories. The user may interact with the interface to switch between different assets, visualizing the changes on the base avatar in real-time. Once the user is satisfied with the configuration (for instance, selecting a specific pullover and hat for a casual call) the specific combination of the base avatar and the selected assets may be finalized.

The API of BAR device 300 may implement one or more layers, alone or in any combination, to facilitate avatar sharing and access control. Such security layers may include any or all of: token-based authentication for all API endpoints, encrypted communication channels using Transport Layer Security (TLS), optional endpoint-to-endpoint encryption for token sharing, granular access control through custom entitlements, and/or temporal validity constraints on access tokens. The API of BAR device 300 may use Hypertext Transfer Protocol (HTTP) status codes for error reporting. The API of BAR device 300 may send detailed error messages in response bodies along with the error reporting. Error scenarios may include invalid tokens, expired access rights, and insufficient permissions for requested operations.

In order to restrict access to users' base avatars, a secure access token mechanism for sharing avatar assets may be used. When UE device 316 is to share avatar assets with other participants in an AR communication session, UE device 316 may generate and encrypt (that is, digitally sign) an access token using its private key. The security may be established through either a private/public key pair or a shared secret key between UE device 316 and BAR device 300.

Access tokens may contain several components for secure avatar sharing, such as any or all of a session identification (e.g., a SIP call identifier or an SDP Session identifier), participant identifiers (e.g., SIP addresses and/or IP addresses), a temporal validity period, and/or custom entitlements, such as avatar/asset identifiers, a list of authorized asset identifiers, and/or permitted levels of detail for each avatar/asset.

When BAR device 300 receives a download request, e.g., from remote UE 324, BAR device 300 may extract an access token from the download request. BAR device 300 may then decrypt the provided token (e.g., using the public key of UE device 316), evaluate the token scope and entitlements, generate a base avatar container file based on the authorized assets, and deliver a response to the requesting entity. The access token signaling may be performed through SDP using an attribute per the techniques of this disclosure. UE device 316 may include the avatar access token in an SDP offer message, with optional encryption using the public key of the remote UE for additional security. The token may have the format: “a=avatar-token:<token-type> <token-value>[<bar-url>].” The following is an example of the avatar signaling using this token format: “a=avatar-token:JWT eyJhbGciOiJFUzI1NiI . . . https://bar.example.com/v1/avatars/{AvatarID}.” JWT stands for “JavaScript Object Notation (JSON) Web Token.” The URL of BAR device 300 may alternatively be obtained through a Scene Description document that can be retrieved via the data channel, e.g., the channel established for the AR communication session.

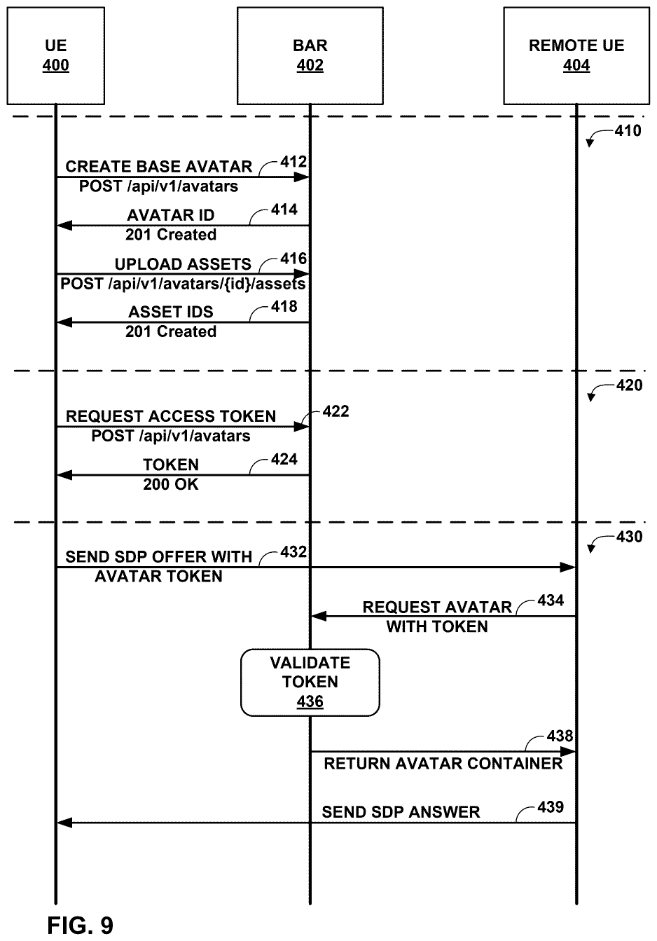

FIG. 9 is a call flow diagram illustrating an example method that may be performed by two (or more) UEs engaged in an AR communication session, along with a base avatar repository (BAR) device. In this example, FIG. 9 depicts UE 400, BAR device 402, and remote UE 404. UE 400 may correspond to UE 12 of FIG. 1, UE 200 of FIG. 5, sending device 236 of FIG. 6, or UE device 316 of FIG. 8. Remote UE 404 may correspond to UE 14 of FIG. 1, XR client device 140 of FIG. 2, UE 200 of FIG. 5, receiving device 240 of FIG. 6, or remote UE 324 of FIG. 8.

Initially, the method includes avatar management phase 410, which occurs before an AR communication session. During avatar management phase 410, a user of UE 400 may generally manage avatars stored by BAR device 402. For example, the user may create one or more base avatars at BAR device 402 using a “POST /api/v1/avatars” command offered by an API of BAR device 402 (412). In response, UE 400 may receive an avatar identifier (ID) in a “201 created” HTTP confirmation message from BAR device 402 (414). The user may also use UE 400 to upload assets associated with one or more of the base avatars using a “POST /api/v1/avatars/{id}/assets” command offered by the API of BAR device 402 (416). In response, BAR device 402 may issue a confirmation to indicate that the assets have been uploaded and identifiers (IDs) for the assets, e.g., using a “201 Created” confirmation (418).

During session initialization phase 420 for an AR communication session, the user may use UE 400 to request an access token associated with their base avatar from BAR device 402, e.g., using a “POST /api/v1/tokens” command offered by the API of BAR device 402 (422). BAR device 402 may respond with a confirmation and the created token, e.g., with a “200 OK” confirmation message (424).

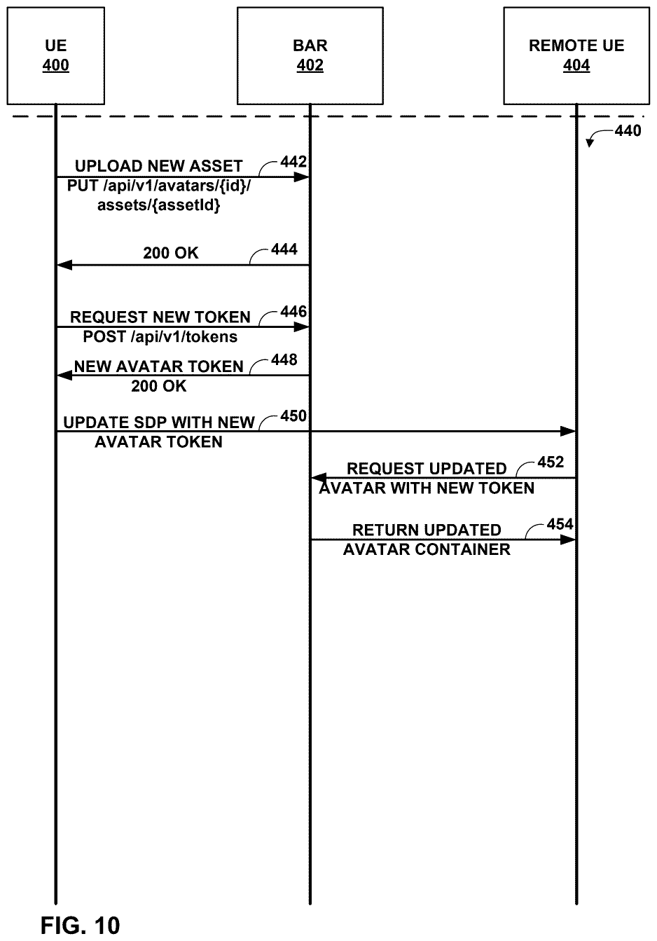

During Session Description Protocol (SDP) signaling phase 430 for the AR communication session, UE 400 may send an SDP offer including an avatar token (e.g., received from BAR device 402) to remote UE 404 that is also to be engaged in the AR communication session (432). Remote UE 404 may then send a request to BAR device 402 for the avatar, where the request includes the avatar token (434). BAR device 402 may then validate the token (436) and prepare the avatar, e.g., encapsulate the avatar and asset data into an avatar container. BAR device 402 may then send the avatar container to remote UE 404 (438). Remote UE 404 may also send an SDP answer to UE 400 to initiate the AR communication session (439). The AR communication session may then become active following the SDP signaling phase, as discussed with respect to FIG. 10.

FIG. 10 is a call flow diagram illustrating an example method that may be performed by two (or more) UEs engaged in an ongoing AR communication session, along with a base avatar repository (BAR) device per techniques of this disclosure. The call flow of FIG. 10 may be performed following the various phases described above with respect to FIG. 9. FIG. 10 also depicts UE 400, BAR device 402, and remote UE 404. FIG. 10 depicts active session phase 440.

While the session is active, the user may use UE 400 to upload assets associated with the base avatar to BAR device 402, e.g., using a “PUT /api/v1/avatars/{id}/assets/{assetID}” command offered by the API of BAR device 402 (442). BAR device 402 may confirm upload of the assets using a “200 OK” confirmation message (444). UE 400 may also request a new token associated with the newly uploaded assets, e.g., using a “POST/api/v1/tokens” command offered by the API of BAR device 402 (446). In response, BAR device 402 may send a new token with a “200 OK” confirmation message (448). UE 400 may update the SDP information with the new avatar token and send an SDP message including the new avatar token to remote UE 404 (450). Remote UE 404 may then use the new avatar token to request the updated avatar and avatar assets from BAR device 402 (452). BAR device 402 may send the updated avatar and avatar assets to remote UE 404 upon confirming authorization using the new avatar token (454).

The access token may be generated by UE 400 or BAR device 402. UE 400 may encrypt the access token using its private key of a public/private key infrastructure. Thus, BAR device 402 may decrypt the access token using the public key associated with the private key and UE 400 to verify that the access token has actually originated from UE 400. The private/public key or symmetric secret key may be established between UE 400 and BAR device 402.

In some examples, the access token may contain a session identifier, such as a Session Initiation Protocol (SIP) call identifier or a Session Description Protocol (SDP) session identifier. The access token may include an optional identifier of an allowed participant to whom the access is granted, e.g., their SIP address, IP address, or other such identifier. If not present, access may be presumed to be granted to all participants of the call indicated by the SIP call identifier or SDP session identifier. The access token may, additionally or alternatively, include temporal validity indicating the time during which access to the base avatar is permitted. In some examples, the access token may include custom entitlements, such as an avatar identifier to identify which base avatar is used, a list of asset identifiers that are used to compose the base avatar, and/or allowed levels of detail for these assets. When BAR device 402 receives a request to download a base avatar, BAR device 402 may decrypt and evaluate the token scope and entitlements. Then BAR device 402 may generate a base avatar container file and respond to the request, e.g., by sending the base avatar container file including the base avatar and avatar assets to the requesting device (assuming the requesting device has successfully been authorized and/or authenticated).

UE 400 may signal the avatar access token as part of the SDP offer, as discussed above. Additional protection may be applied to limit access to the actual token to remote UE 404, e.g., by encrypting the access token with the public key of remote UE 404. The access token may conform to the following syntax: “a=avatar-token:<token-type> <token-value>[<bar-url>].” The BAR URL represents a uniform resource locator (URL) for BAR device 402. The BAR URL may alternatively be discovered through a Binding Support Function (BSF) or as part of a Scene Description document. An example of such an avatar signaling is: “a=avatar-token:JWT eyJhbGciOiJFUzI1NiI . . . https://bar.example.com/v1.”

In this manner, the techniques of this disclosure include management of avatar resources and an authorization mechanism during an AR communication session (e.g., an IMS call) to allow access to a selected subset of assets of a base avatar of a user.

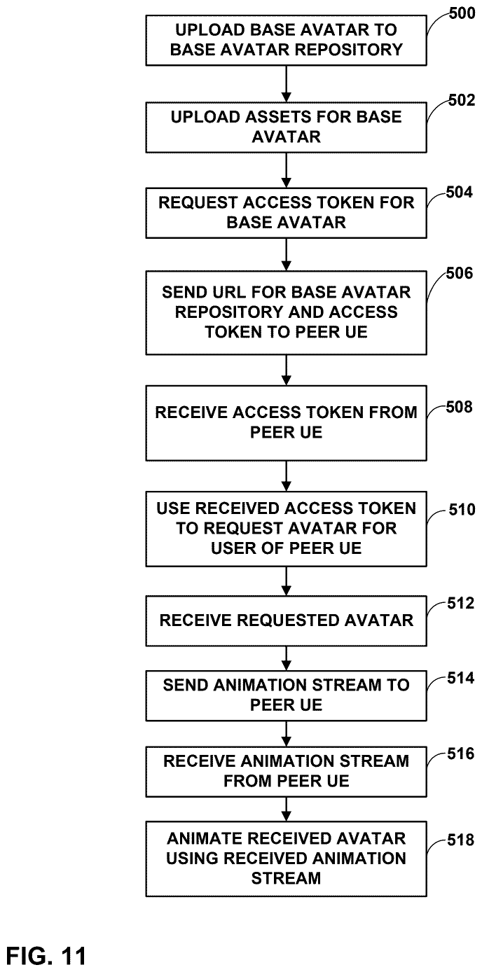

FIG. 11 is a flowchart illustrating an example method of participating in an AR communication session per techniques of this disclosure. The method of FIG. 11 is described with respect to UE 200 of FIG. 5. However, other devices, such as UE 12 of FIG. 1, UE 182 of FIG. 4, sending device 236 of FIG. 6, or UE 316 of FIG. 8, may also perform this or a similar method.

Initially, UE 200 uploads a base avatar to a base avatar repository (BAR) device (500). UE 200 may also upload one or more assets for the base avatar (502). UE 200 may obtain these new avatar assets from user input, a digital marketplace, or other sources. UE 200 may also request the deletion of at least one avatar asset, or the entire avatar.

UE 200 then requests an access token for the base avatar from the BAR device (504). In some examples, UE 200 may generate and send the access token to the BAR device. In other examples, UE 200 may request that the BAR device generate the access token and send the access token to UE 200.

UE 200 may then send a URL for the BAR device and the access token to a peer UE (506). For example, UE 200 may form or update a scene description to include the access token and the URL for the BAR device. This may grant the peer UE access to the avatar associated with the user of UE 200.

UE 200 may also receive an access token from the peer UE (508), and use the received access token to request an avatar for a user of the peer UE (510), e.g., from the BAR device or a different BAR device. In response to the request, UE 200 may receive the requested avatar (512).

UE 200 and the peer UE may then participate in an AR communication session. During the AR communication session, UE 200 may send an animation stream to the peer UE (514) and receive an animation stream from the peer UE (516). UE 200 may animate the received avatar using the received animation stream (518) and present the animated avatar on a display. UE 200 may generate the animation stream sent to the peer UE based on captured movements of the user of UE 200, e.g., body movements, facial expressions, or the like.

In this manner, the method of FIG. 11 represents an example of a method of communicating augmented reality (AR) media data, including: obtaining data representing a base avatar and one or more avatar assets associated with an AR user, wherein the data indicates that a base avatar repository device stores the base avatar and the one or more assets; initiating an AR communication session including the user; and sending an access token to a client device associated with at least one other user involved in the AR communication session, the access token indicating that the at least one other user has access to the base avatar and a selection of the one or more avatar assets.

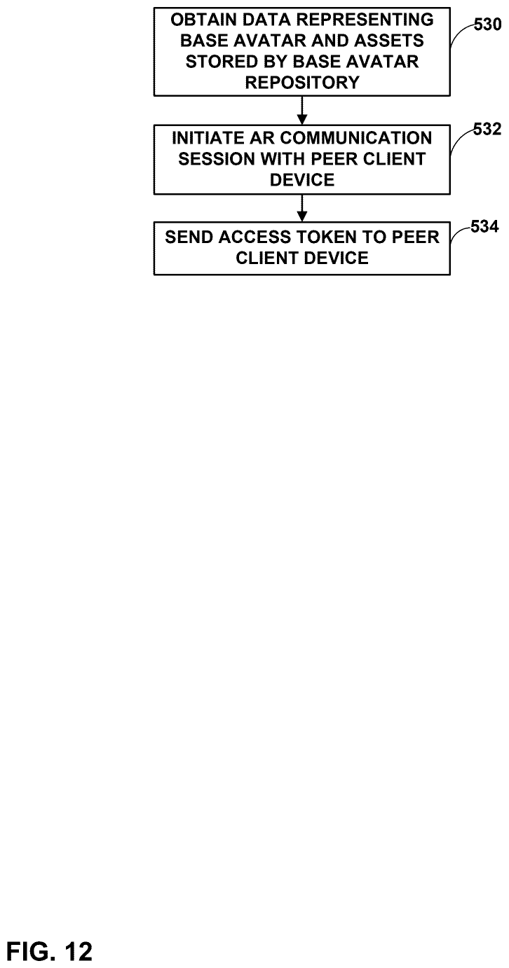

FIG. 12 is a flowchart illustrating an example method of participating in an AR communication session per techniques of this disclosure. The method of FIG. 12 is described as being performed by UE 200 of FIG. 5. However, other devices, such as, UE 12 of FIG. 1, UE 182 of FIG. 4, sending device 236 of FIG. 6, or UE 316 of FIG. 8 may perform this or a similar method.

Initially, UE 200 obtains data representing a base avatar and one or more avatar assets associated with an AR user, i.e., the user of UE 200. The data indicates that a base avatar repository (BAR) device stores the base avatar and the one or more assets (530). For example, the data representing the base avatar may include data representing a plurality of base avatars owned by the AR user and, for each of the plurality of base avatars, a list of avatar assets associated with the base avatar.

UE 200 then initiates an AR communication session including the user with a peer UE (532). UE 200 may generate an access token or request that the BAR device generate the access token for at least one other user involved in the AR communication session. In some examples, when the at least one other user includes a plurality of other users, generating the access token may include generating the access token as a single access token for each of the plurality of other users collectively. In some examples, when the at least one other user includes multiple other users, generating the access token includes generating respective, distinct access tokens for each of the other users.

The access token may include data representing one or more of a session identification associated with the AR communication session, an identifier of the at least one other user, a time during which access to the base avatar is permitted, an identifier associated with the base avatar, a list of asset identifiers used to compose the base avatar, or permitted levels of detail associated with assets corresponding to the list of asset identifiers.

UE 200 may further sign or encrypt the access token with a private key of a public/private key pair associated with the user of UE 200. UE 200 then sends the access token to the peer UE associated with the at least one other user (534). Sending the access token may include sending the access token as part of a Session Description Protocol (SDP) offer message to the peer UE. In some examples, sending the access token includes sending data conforming to a syntax of “a=avatar-token:<token-type> <token-value>[<bar-url>],” where <bar-url> represents a uniform resource locator (URL) associated with the BAR device.

In some examples, UE 200 also receives a second access token from the peer UE associated with the at least one other user. UE 200 may then send a request to access a base avatar associated with the at least one other user to the BAR device, where the request includes the second access token. In such cases, UE 200 may receive the base avatar associated with the at least one other user, receive an animation stream for the base avatar, and present an animated version of the base avatar according to the animation stream.

In this manner, the method of FIG. 11 represents an example of a method of communicating augmented reality (AR) media data, including: obtaining data representing a base avatar and one or more avatar assets associated with an AR user, wherein the data indicates that a base avatar repository device stores the base avatar and the one or more assets; initiating an AR communication session including the user; and sending an access token to a client device associated with at least one other user involved in the AR communication session, the access token indicating that the at least one other user has access to the base avatar and a selection of the one or more avatar assets.

Various examples of the techniques of this disclosure are summarized in the following clauses:
Clause 1: A method of communicating augmented reality (AR) media data, the method comprising: obtaining data representing a base avatar and one or more avatar assets associated with an AR user, wherein the data indicates that a base avatar repository device stores the base avatar and the one or more assets; initiating an AR communication session including the user; generating an access token for at least one other user involved in the AR communication session indicating that the at least one other user has access to the base avatar and a selection of the one or more avatar assets; and sending the access token to a client device associated with the at least one other user.
Clause 2: The method of clause 1, wherein the at least one other user includes a plurality of other users, and wherein generating the access token comprises generating the access token as a single access token for each of the plurality of other users collectively.
Clause 3: The method of clause 1, wherein the at least one other user includes a plurality of other users, and wherein generating the access token comprises generating respective, distinct access tokens for each of the plurality of other users.
Clause 4: The method of any of clauses 1-3, further comprising: obtaining at least one new avatar asset for the base avatar; and sending data representing the at least one new avatar asset to the base avatar repository device.
Clause 5: The method of any of clauses 1-4, further comprising requesting deletion of at least one avatar asset associated with the base avatar.
Clause 6: The method of any of clauses 1-5, wherein the data representing the base avatar comprises data representing a plurality of base avatars and, for each of the plurality of base avatars, a list of avatar assets associated with the base avatar.
Clause 7: The method of any of clauses 1-6, wherein generating the access token comprises generating the access token to include data representing one or more of a session identification associated with the AR communication session, an identifier of the at least one other user, a time during which the access to the base avatar is permitted, an identifier associated with the base avatar, a list of asset identifiers used to compose the base avatar, or permitted levels of detail associated with assets corresponding to the list of asset identifiers.
Clause 8: The method of clause 7, further comprising signing or encrypting the access token with a private key of a public/private key pair associated with the user.
Clause 9: The method of any of clauses 1-8, wherein sending the access token comprises sending the access token as part of a Session Description Protocol (SDP) offer message to the client device associated with the at least one other user.
Clause 10: The method of any of clauses 1-9, wherein sending the access token comprises sending data conforming to syntax comprising “a=avatar-token:<token-type> <token-value>[<bar-url>],” wherein <bar-url> comprises a uniform resource locator (URL) associated with the base avatar repository device.
Clause 11: The method of any of clauses 1-10, wherein the access token comprises a first access token, the method further comprising: receiving a second access token from the client device associated with the at least one other user; and sending a request to access a base avatar associated with the at least one other user to the base avatar repository device, the request including the second access token.
Clause 12: The method of clause 11, further comprising: receiving the base avatar associated with the at least one other user; receiving an animation stream for the base avatar associated with the at least one other user; and presenting an animated version of the base avatar associated with the at least one other user according to the animation stream.
Clause 13: A device for communicating augmented reality (AR) media data, the device comprising one or more means for performing the method of any of clauses 1-12.
Clause 14: The device of clause 13, wherein the one or more means comprise a memory for storing media data and a processing system implemented in circuitry.
Clause 15: A device for communicating augmented reality (AR) media data, the device comprising: means for obtaining data representing a base avatar and one or more avatar assets associated with an AR user, wherein the data indicates that a base avatar repository device stores the base avatar and the one or more assets; means for initiating an AR communication session including the user; means for generating an access token for at least one other user involved in the AR communication session indicating that the at least one other user has access to the base avatar and a selection of the one or more avatar assets; and means for sending the access token to a client device associated with the at least one other user.
Clause 16: A method of communicating augmented reality (AR) media data, the method comprising: obtaining data representing a base avatar and one or more avatar assets associated with an AR user, wherein the data indicates that a base avatar repository device stores the base avatar and the one or more assets; initiating an AR communication session including the user; and sending an access token to a client device associated with at least one other user involved in the AR communication session, the access token indicating that the at least one other user has access to the base avatar and a selection of the one or more avatar assets.
Clause 17: The method of clause 16, wherein the at least one other user includes a plurality of other users, and wherein sending the access token comprises sending a common access token to each of the plurality of other users.
Clause 18: The method of clause 16, wherein the at least one other user includes a plurality of other users, and wherein sending the access token comprises sending respective, distinct access tokens to each of the plurality of other users.
Clause 19: The method of any of clauses 16-18, further comprising, prior to obtaining the data representing the base avatar and the one or more avatar assets associated with the AR user: sending a first request to the base avatar repository to create an avatar representation format (ARF) container for the base avatar; and sending a second request to the base avatar repository to upload the one or more avatar assets for the base avatar to the base avatar repository.
Clause 20: The method of any of clauses 16-19, further comprising: obtaining at least one new avatar asset for the base avatar; and sending data representing the at least one new avatar asset to the base avatar repository device.
Clause 21: The method of any of clauses 16-20, further comprising requesting deletion of at least one avatar asset associated with the base avatar.
Clause 22: The method of any of clauses 16-21, wherein the data representing the base avatar comprises data representing a plurality of base avatars and, for each of the plurality of base avatars, a list of avatar assets associated with the base avatar.
Clause 23: The method of any of clauses 16-22, wherein the access token includes data representing one or more of a session identification associated with the AR communication session, an identifier of the at least one other user, a time during which the access to the base avatar is permitted, an identifier associated with the base avatar, a list of asset identifiers used to compose the base avatar, or permitted levels of detail associated with assets corresponding to the list of asset identifiers.
Clause 24: The method of clause 23, further comprising signing or encrypting the access token with a private key of a public/private key pair associated with the user.
Clause 25: The method of any of clauses 16-24, wherein sending the access token comprises sending the access token as part of a Session Description Protocol (SDP) offer message to the client device associated with the at least one other user.
Clause 26: The method of any of clauses 16-25, wherein sending the access token comprises sending data conforming to syntax comprising “a=avatar-token:<token-type> <token-value>[<bar-url>],” wherein <bar-url> comprises a uniform resource locator (URL) associated with the base avatar repository device.
Clause 27: The method of any of clauses 16-26, wherein the access token comprises a first access token, the method further comprising: receiving a second access token from the client device associated with the at least one other user; and sending a request to access a base avatar associated with the at least one other user to the base avatar repository device, the request including the second access token.
Clause 28: The method of clause 27, further comprising: receiving the base avatar associated with the at least one other user; receiving an animation stream for the base avatar associated with the at least one other user; and presenting an animated version of the base avatar associated with the at least one other user according to the animation stream.
Clause 29: A device for communicating augmented reality (AR) media data, the device comprising: a memory configured to store media data; and a processing system implemented in circuitry and configured to: obtain data representing a base avatar and one or more avatar assets associated with an AR user, wherein the data indicates that a base avatar repository device stores the base avatar and the one or more assets; initiate an AR communication session including the user; and send an access token to a client device associated with at least one other user involved in the AR communication session, the access token indicating that the at least one other user has access to the base avatar and a selection of the one or more avatar assets.
Clause 30: The device of clause 29, wherein the processing system is further configured to, prior to obtaining the data representing the base avatar and the one or more avatar assets: send a first request to the base avatar repository to create an avatar representation format (ARF) container for the base avatar; and send a second request to the base avatar repository to upload the one or more avatar assets for the base avatar to the base avatar repository.
Clause 31: The device of any of clauses 29 and 30, wherein the processing system is further configured to: obtain at least one new avatar asset for the base avatar; and send data representing the at least one new avatar asset to the base avatar repository device.
Clause 32: The device of any of clauses 29-31, wherein the processing system is further configured to request deletion of at least one avatar asset associated with the base avatar.
Clause 33: The device of any of clauses 29-32, wherein the access token includes data representing one or more of a session identification associated with the AR communication session, an identifier of the at least one other user, a time during which the access to the base avatar is permitted, an identifier associated with the base avatar, a list of asset identifiers used to compose the base avatar, or permitted levels of detail associated with assets corresponding to the list of asset identifiers.
Clause 34: The device of any of clauses 29-33, wherein the access token comprises a first access token, and wherein the processing system is further configured to: receive a second access token from the client device associated with the at least one other user; and send a request to access a base avatar associated with the at least one other user to the base avatar repository device, the request including the second access token.
Clause 35: The device of clause 34, wherein the processing system is further configured to: receive the base avatar associated with the at least one other user; receive an animation stream for the base avatar associated with the at least one other user; and present an animated version of the base avatar associated with the at least one other user according to the animation stream.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of communicating augmented reality (AR) media data, the method comprising:
obtaining data representing a base avatar and one or more avatar assets associated with an AR user, wherein the data indicates that a base avatar repository device stores the base avatar and the one or more avatar assets;
initiating an AR communication session including the AR user; and
sending an access token to a client device associated with at least one other user involved in the AR communication session, the access token indicating that the at least one other user has access to the base avatar and a selection of the one or more avatar assets.

2. The method of claim 1, wherein the at least one other user includes a plurality of other users, and wherein sending the access token comprises sending a common access token to each of the plurality of other users.

3. The method of claim 1, wherein the at least one other user includes a plurality of other users, and wherein sending the access token comprises sending respective, distinct access tokens to each of the plurality of other users.

4. The method of claim 1, further comprising, prior to obtaining the data representing the base avatar and the one or more avatar assets associated with the AR user:
sending a first request to the base avatar repository device to create an avatar representation format (ARF) container for the base avatar; and
sending a second request to the base avatar repository device to upload the one or more avatar assets for the base avatar to the base avatar repository device.

5. The method of claim 1, further comprising:
obtaining at least one new avatar asset for the base avatar; and
sending data representing the at least one new avatar asset to the base avatar repository device.

6. The method of claim 1, further comprising requesting deletion of at least one avatar asset associated with the base avatar.

7. The method of claim 1, wherein the data representing the base avatar comprises data representing a plurality of base avatars and, for each of the plurality of base avatars, a list of avatar assets associated with the base avatar.

8. The method of claim 1, wherein the access token includes data representing one or more of a session identification associated with the AR communication session, an identifier of the at least one other user, a time during which the access to the base avatar is permitted, an identifier associated with the base avatar, a list of asset identifiers used to compose the base avatar, or permitted levels of detail associated with assets corresponding to the list of asset identifiers.

9. The method of claim 8, further comprising signing or encrypting the access token with a private key of a public/private key pair associated with the AR user.

10. The method of claim 1, wherein sending the access token comprises sending the access token as part of a Session Description Protocol (SDP) offer message to the client device associated with the at least one other user.

11. The method of claim 1, wherein sending the access token comprises sending data conforming to syntax comprising “a=avatar-token:<token-type> <token-value>[<bar-url>],” wherein <bar-url> comprises a uniform resource locator (URL) associated with the base avatar repository device.

12. The method of claim 1, wherein the access token comprises a first access token, the method further comprising:
receiving a second access token from the client device associated with the at least one other user; and
sending a request to access a base avatar associated with the at least one other user to the base avatar repository device, the request including the second access token.

13. The method of claim 12, further comprising:
receiving the base avatar associated with the at least one other user;
receiving an animation stream for the base avatar associated with the at least one other user; and
presenting an animated version of the base avatar associated with the at least one other user according to the animation stream.

14. A device for communicating augmented reality (AR) media data, the device comprising:
a memory configured to store media data; and
a processing system implemented in circuitry and configured to:
obtain data representing a base avatar and one or more avatar assets associated with an AR user, wherein the data indicates that a base avatar repository device stores the base avatar and the one or more avatar assets;
initiate an AR communication session including the AR user; and
send an access token to a client device associated with at least one other user involved in the AR communication session, the access token indicating that the at least one other user has access to the base avatar and a selection of the one or more avatar assets.

15. The device of claim 14, wherein the processing system is further configured to, prior to obtaining the data representing the base avatar and the one or more avatar assets:
send a first request to the base avatar repository device to create an avatar representation format (ARF) container for the base avatar; and
send a second request to the base avatar repository device to upload the one or more avatar assets for the base avatar to the base avatar repository device.

16. The device of claim 14, wherein the processing system is further configured to:
obtain at least one new avatar asset for the base avatar; and
send data representing the at least one new avatar asset to the base avatar repository device.

17. The device of claim 14, wherein the processing system is further configured to request deletion of at least one avatar asset associated with the base avatar.

18. The device of claim 14, wherein the access token includes data representing one or more of a session identification associated with the AR communication session, an identifier of the at least one other user, a time during which the access to the base avatar is permitted, an identifier associated with the base avatar, a list of asset identifiers used to compose the base avatar, or permitted levels of detail associated with assets corresponding to the list of asset identifiers.

19. The device of claim 14, wherein the access token comprises a first access token, and wherein the processing system is further configured to:
receive a second access token from the client device associated with the at least one other user; and
send a request to access a base avatar associated with the at least one other user to the base avatar repository device, the request including the second access token.

20. The device of claim 19, wherein the processing system is further configured to:
receive the base avatar associated with the at least one other user;
receive an animation stream for the base avatar associated with the at least one other user; and
present an animated version of the base avatar associated with the at least one other user according to the animation stream.
